(19) United States
(12) Patent Application Publication
(10) Pub. No.: US 2021/0359530 A1
(43) Pub. Date: Nov. 18, 2021

(54) Beauty Charger

(71) Applicant: Joshua Tyson, New York, NY (US)

(72) Inventor: Joshua Tyson, New York, NY (US)

(21) Appl. No.: 16/873,592

(22) Filed: May 14, 2020

(51) Int. Cl. H02J 7/00; H04B 1/3883; A46B 9/02; A46B 15/00; A45D 40/00

(52) U.S. Cl. CPC H02J 7/0045; H04B 1/3883; A46B 9/023; A46B 15/0022; A45D 2200/20; A45D 40/00; A46B 2200/104; A46B 2200/1046; A45D 2040/0025; A46B 9/021

(57) ABSTRACT

The beauty charger is a beauty accessory that is combined with an internal cell phone charger. Beauty chargers come in the form of hairbrushes, cosmetic brushes and lipstick cylinders that have the capacity to charge cell phones. The design of the beauty charger fuses the beauty industry with the tech industry. Beauty chargers enhance common beauty accessories by enabling them with the ability to also be utilized as a cell phone charger when necessary. Beauty chargers alleviate the necessity of carrying independent cell phone chargers and separate beauty accessories in a handbag or purse.

### BACKGROUND

Beauty chargers are comprised of beauty accessories such as hairbrushes, lipstick cylinders and cosmetic brushes. These beauty accessories are all integrated with cell phone chargers. They all serve their conventional function as a beauty tool and can also be utilized as a cell phone charger. In the current state of art hairbrushes, cosmetic brushes and lipstick are used as beauty accessories for grooming and makeup application. In the most current art cell phone chargers are used independently for charging cell phones. The invention of the beauty charger improves upon prior art by integrating a cell phone charger with beauty accessories. Beauty chargers alleviate the necessary of carrying an independent cell phone charger in addition to separate beauty accessories in a purse or handbag

### BRIEF DESCRIPTION OF DRAWINGS

FIG. 1 drawing shows a three dimensional view of a cell phone with a beauty charger cosmetic brush attached with a usb cable 2, and a partial view of an activation button on handle

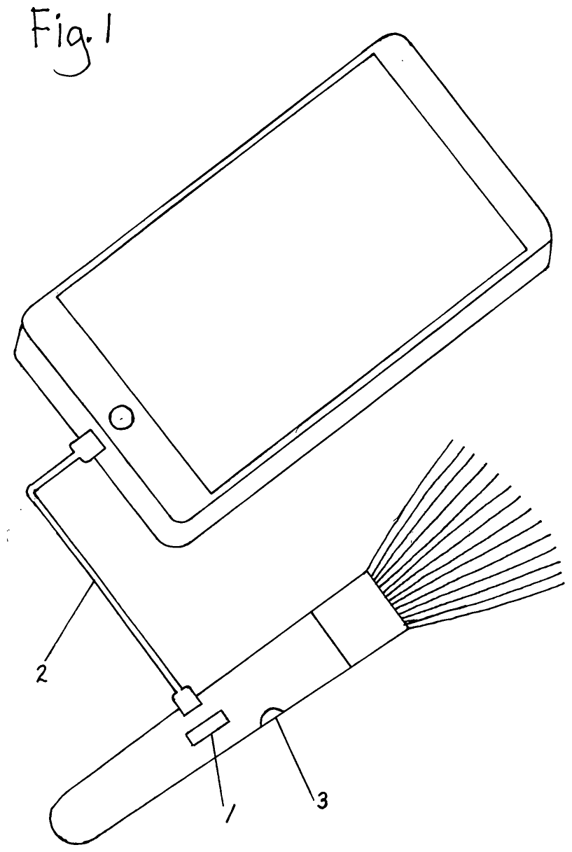

FIG. 2 drawing shows front view of a beauty charger cosmetic brush with usb ports 1, and partial view of the activation button on handle

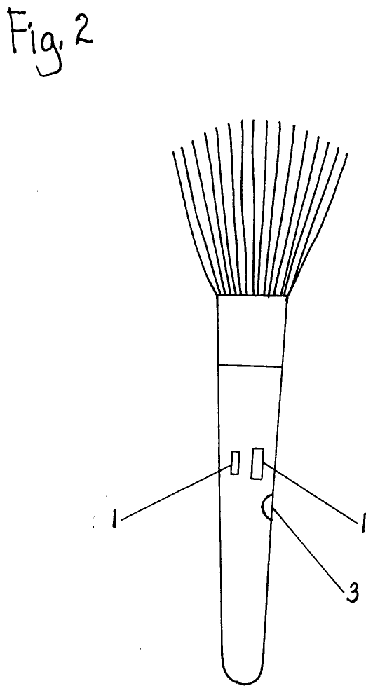

FIG. 3 this illustration shows a three dimensional view of a beauty charger lipstick cylinder with usb ports 1, on cylinder, the lipstick encasement is replaceable

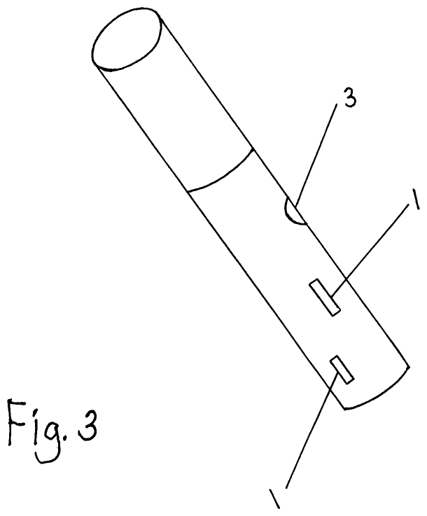

FIG. 4 drawing shows a three dimensional view of a cell phone with a lipstick beauty charger attached to cell phone with a usb cable 2. This drawing also shows beauty chargers activation button 3, on cylinder

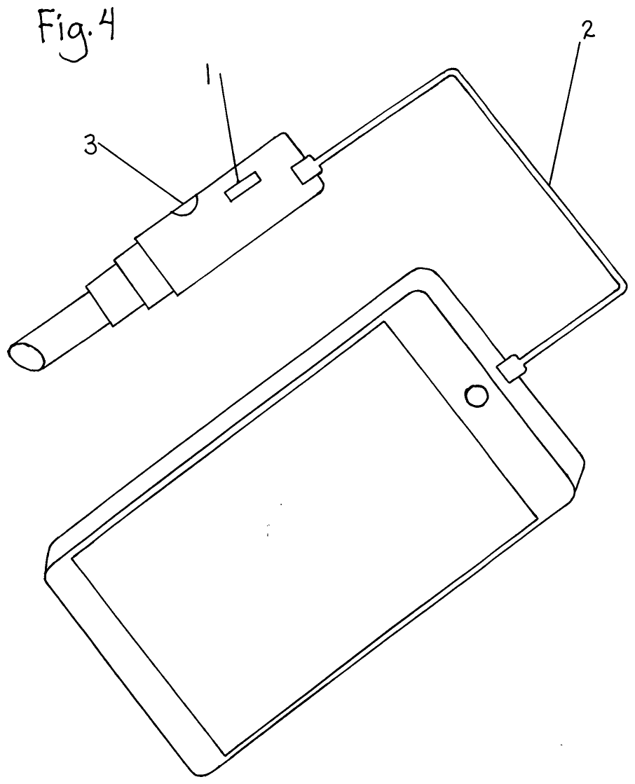

FIG. 5 drawing shows three dimensional view of a cell phone and beauty charger hairbrush attached with usb cable 2, this drawing also shows a usb port 1, and a partial view of an activation button on handle

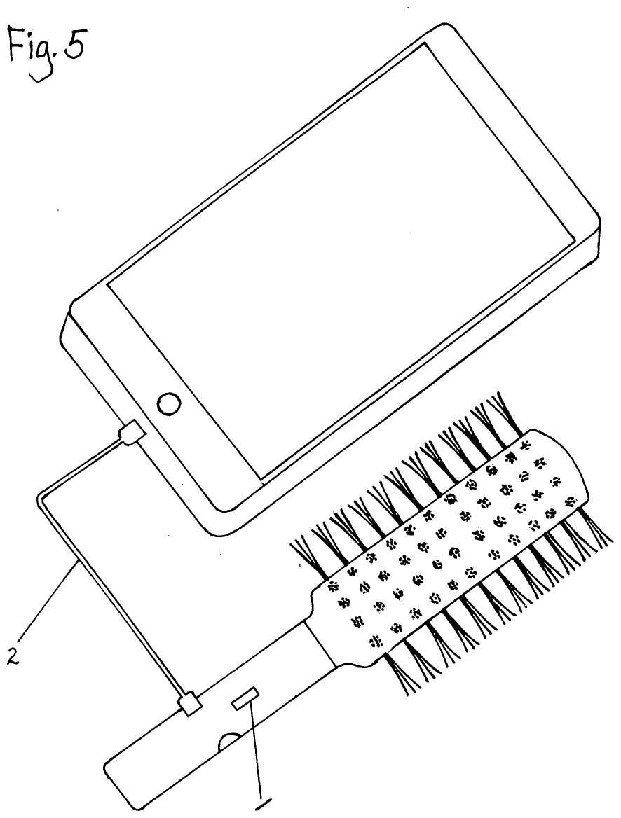

FIG. 6 drawing shows front view of a beauty charger hairbrush with handle separated from bristle brush head, brush handle has usb ports 1, on it

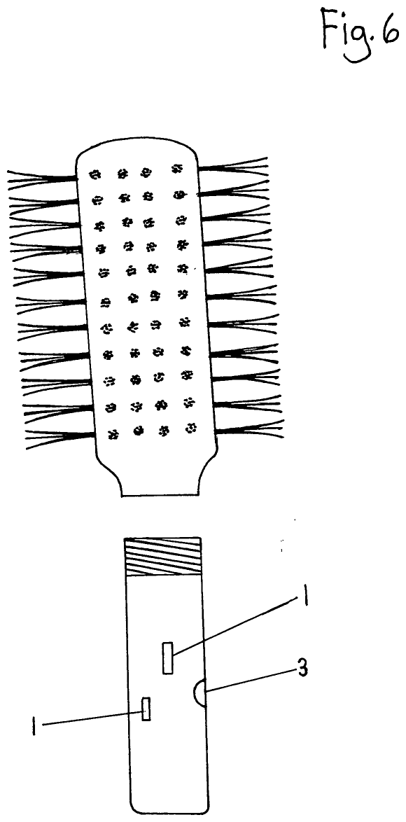

FIG. 7 drawing shows front view of a beauty chargers usb charger

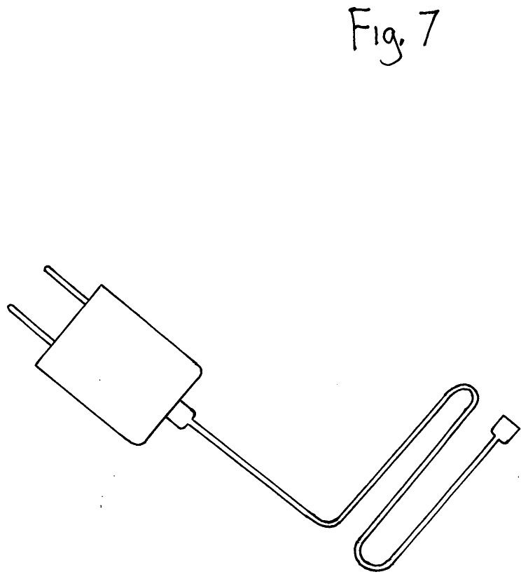

### SUMMARY

In brief summary the innovation of the beauty charger's technical ability to charge cell phones from common beauty accessories compliments the use of hairbrushes, lipstick cylinders and cosmetic brushes. These beauty accessories all have an internal ubs charging device. One definitive improvement of the beauty charger is the fusion of a cell phone charger incorporated internally into these beauty accessories. The integration of these two products alleviate the demand of carrying beauty accessories and a cell phone charger independently.

### Beauty Charger

Beauty chargers are everyday beauty accessories that are integrated with an internal cell phone charger. These beauty accessories are comprised of hairbrushes, cosmetic brushes and lipstick cylinders. All these beauty accessories perform dual functions, first as a conventional beauty tool and second having the capacity to operate as a cell phone charger. Beauty chargers can be used to charge cell phones and other small electronic devices. The charging mechanism is located in the interior of the beauty accessory. Beauty chargers have usb cable ports for charging. Beauty chargers maximize the use of beauty accessories by integrating in its interior a cell phone charger. Beauty chargers alleviate the necessity of carrying an independent cell phone charger and separate beauty accessories in a purse or handbag. Beauty chargers are lightweight, compact and easy to travel with.

1. Conventional beauty accessories comprised of hairbrushes, lipstick cylinders and cosmetic brushes all having the capacity to charge cell phones
Beauty accessories with usb ports for charging cell phones
Conventional beauty accessories with the capacity to charge at least one cell phone

2. Beauty accessories with internal charging mechanisms for charging cell phones and other small electronic devices

3. Conventional beauty accessories such as hairbrushes, lipstick cylinders and cosmetic brushes all integrated with a cell phone charger
